(19) United States
(12) Patent Application Publication
(10) Pub. No.: US 2017/0316257 A1
(43) Pub. Date: Nov. 2, 2017

(54) DEVICE AND METHOD FOR MONITORING PEOPLE, METHOD FOR COUNTING PEOPLE AT A LOCATION

(71) Applicant: HON HAI PRECISION INDUSTRY CO., LTD., New Taipei (TW)

(72) Inventor: WEI-CHUN CHEN, New Taipei (TW)

(21) Appl. No.: 15/141,853

(22) Filed: Apr. 29, 2016

(30) Foreign Application Priority Data
Apr. 28, 2016 (TW) 105113348

(51) Int. Cl. G06K 9/00; G06K 9/46; G06K 9/52; G06T 5/00; G06K 9/62; G06T 7/60

(52) U.S. Cl. CPC G06K 9/00335; G06K 9/6267; G06K 9/4652; G06T 7/60; G06T 5/00; G06K 9/00362; G06K 9/6201; G06K 9/52; G06T 2207/30196; G06T 2207/30242

(57) ABSTRACT

A monitoring device to monitor and to count people in a certain area includes an extracting module to extract images of persons from a first signal; and a computing module to process the images of persons from the extracting module. The extracting module removes background of the first signal and extracts images of persons for the computing module. The computing module obtains coordinates of a center of each image of persons and a value of hue of each image of persons. The computing module can match images of persons to persons to be monitored and can constantly determine the instant number of persons being monitored.

### FIELD

The subject matter herein generally relates to a device and a method for monitoring people, and a method for monitoring and counting people.

### BACKGROUND

To monitor a plurality of persons, their individual features can be established and the individual people tracked.

### BRIEF DESCRIPTION OF THE DRAWINGS

Implementations of the present technology will now be described, by way of example only, with reference to the attached figures.

FIG. 1 is a block diagram of an embodiment of a monitoring device of the present disclosure.

FIG. 2 is a schematic diagram of an embodiment of an extracting module of the monitoring device in FIG. 1.

FIG. 3 is another schematic diagram of the embodiment of the extracting module in FIG. 2.

FIG. 4 is a schematic diagram of an embodiment of a first process of a computing module of the monitoring device in FIG. 1.

FIG. 5 is a schematic diagram of a second process of the computing module in FIG. 4.

FIG. 6 is a schematic diagram of a third process of the computing module in FIG. 4.

FIG. 7 is a schematic diagram of a fourth process of the computing module in FIG. 4.

FIG. 8 is a schematic diagram of a fifth process of the computing module in FIG. 4.

FIG. 9 is a schematic diagram of a sixth process of the computing module in FIG. 4.

FIG. 10 is a schematic diagram of a seventh process of the computing module in FIG. 4.

FIG. 11 is a schematic diagram of an eighth process of the computing module in FIG. 4.

FIG. 12 is a schematic diagram of an embodiment of the monitoring device for counting people.

FIG. 13 is a schematic diagram of an embodiment of the monitoring device for counting people.

FIG. 14 is a flow chart of an embodiment of a monitoring method of the present disclosure.

FIG. 15 is a flow chart of an embodiment of a counting method of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently coupled or releasably coupled. The term “comprising,” when utilized, means “including, but not necessarily limited to”; it specifically indicates open-ended inclusion or membership in the so-described combination, group, series and the like.

The disclosure will now be described in relation to a monitoring device.

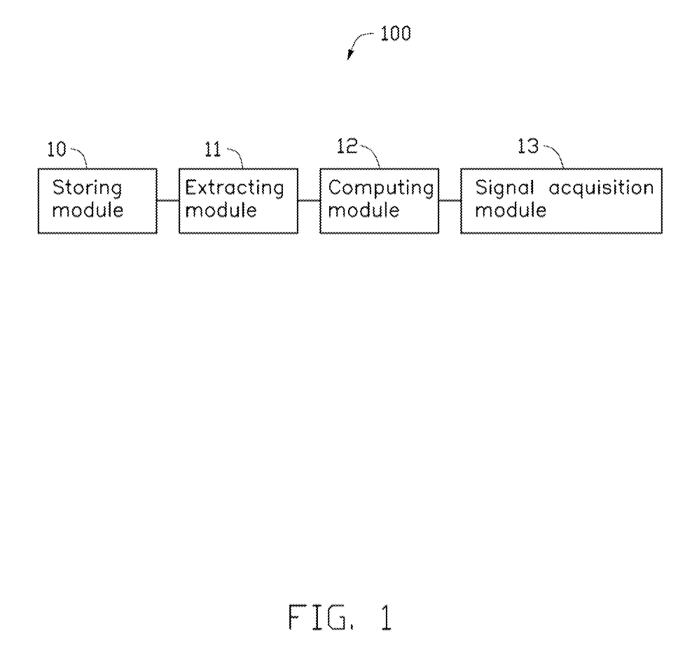

FIG. 1 illustrates a monitoring device 100.

The monitoring device 100 can comprise a storing module 10, an extracting module 11, a computing module 12, and a signal acquisition module 13.

The signal acquisition module 13 is configured to provide a first signal of image or video.

In one embodiment, the signal acquisition module 13 can comprise a camera.

In one embodiment, the signal acquisition module 13 may get the first external signal.

The storing module 10 is configured to store personal information of persons to be monitored. The personal information can comprise color information.

The extracting module 11 is configured to receive the first signal from the signal acquisition module 13. The extracting module 11 is also configured to extract images of persons from the first signal.

The computing module 12 is configured to process the images of persons extracted by the extracting module 11.

In one embodiment, the computing module 12 compares the extracted images of persons to personal information stored in the storing module 10, to establish a mapping relationship. Thus, the computing module 12 matches the extracted images of persons to personal information stored in the storing module 10.

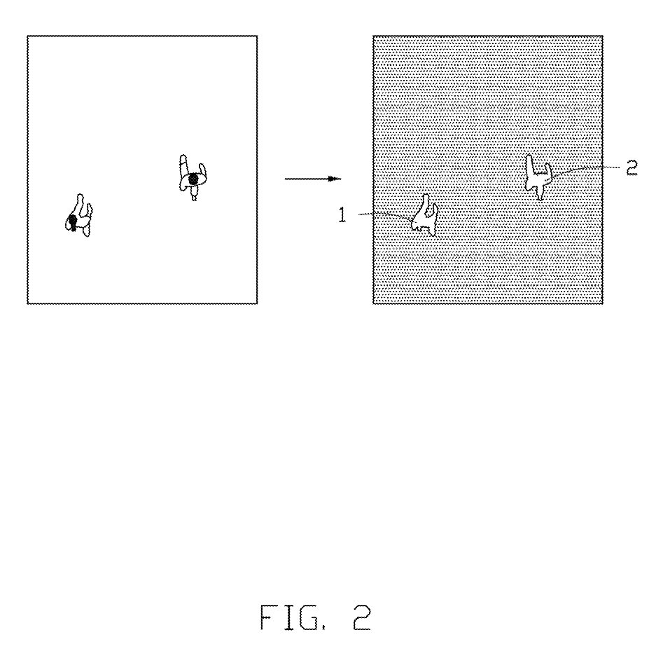

FIG. 2 illustrates an embodiment of the extracting module 11. The extracting module 11 is configured to remove a background of an image of the first signal.

The extracted images of persons can comprise a first image 1 and a second image 2. The first image 1 is on the left-hand-side of FIG. 2 corresponding to the second image 2.

The extracting module 11 analyzes pixels which may be comprised in the images of persons through connected component analysis-labeling. The extracting module 11 crops or cuts the images of persons from the image of the first signal.

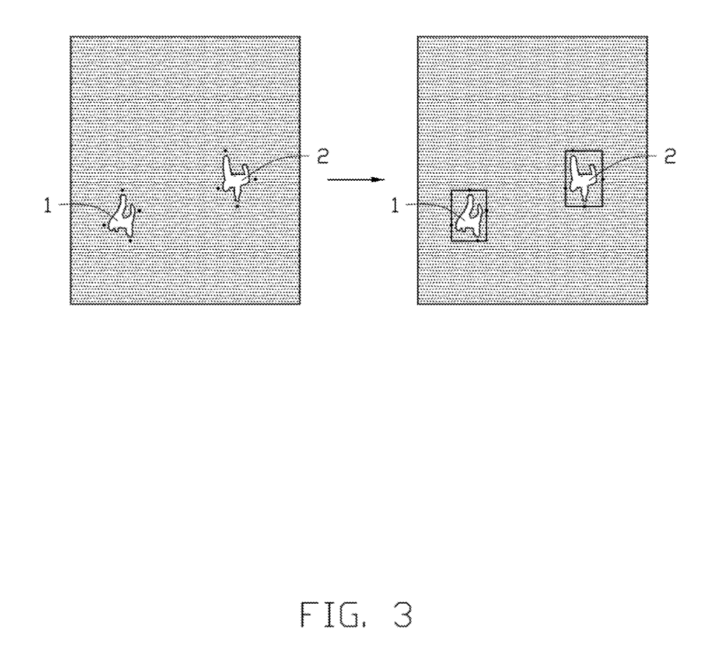

FIG. 3 illustrates an image-cutting process that the extracting module 11 uses to cut the images of persons off from the image of the first signal.

In the embodiment, the extracting module 11 marks four endpoints of the first image 1.

The four endpoints are configured to indicate the leftmost, the rightmost, the topmost, and the bottommost points of the first image 1.

Similarly, the extracting module 11 marks four endpoints of the second image 2. The four endpoints are configured to indicate the leftmost, the rightmost, the topmost, and the bottommost of the second image 2.

The extracting module 11 cuts the first image 1 and the second image 2 off from the image of the first signal.

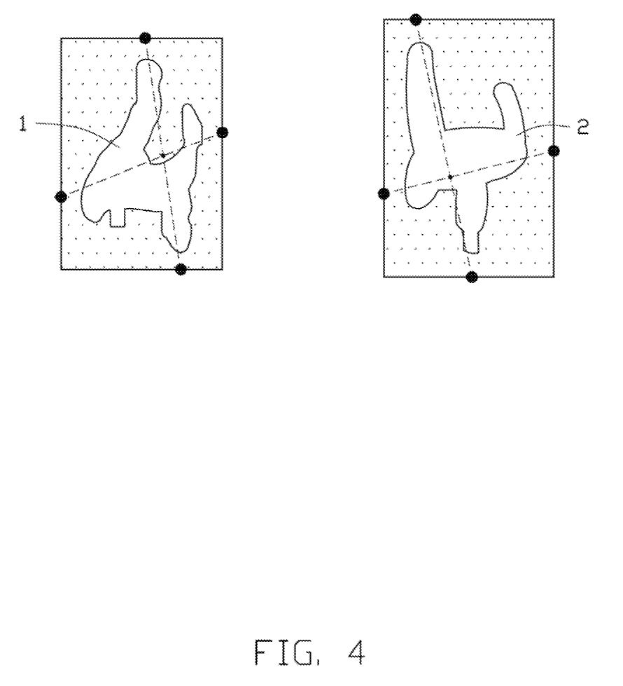

FIG. 4 illustrates a first process used by the computing module 12 to establish the centers of the first image 1 and of the second image 2.

A central attachment point of the four endpoints of the first image 1 is regarded as the center of the first image 1. Coordinates of the center of the first images are defined as (a1, b1).

A central attachment point of the four endpoints of the second image 2 is regarded as the center of the second image 2. Coordinates of the center of the second images are defined as (a2, b2).

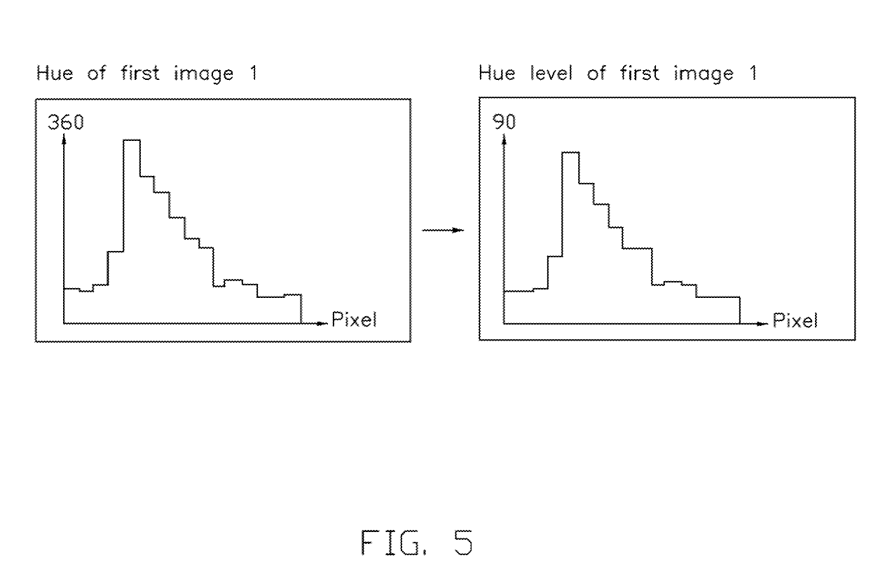

FIG. 5 illustrates a second process used by the computing module 12 to process the first image 1 to achieve a value of Hue and a value of Hue level of the first image 1.

The computing module 12 processes RGB (red, green, blue) information of the first image 1. The computing module 12 gets a HSV (hue, saturation, value) information of the first image 1, according to a preset formula, based on RGB information of the first image 1.

A value of hue can be used to distinguish different persons.

In the embodiment, a value of hue level can be obtained through multiplying the value of hue by four.

In a histogram of the value of hue of the first image 1 in FIG. 5, a small difference in the value of hue can be regarded as not affecting the value of hue level. Thus, errors caused by light or lighting angles can be reduced.

The histogram of the value of hue of the first image 1 is similar to a histogram of the value of hue level of the first image 1. Thus, the hue level of the first image 1 can be configured to distinguish between persons.

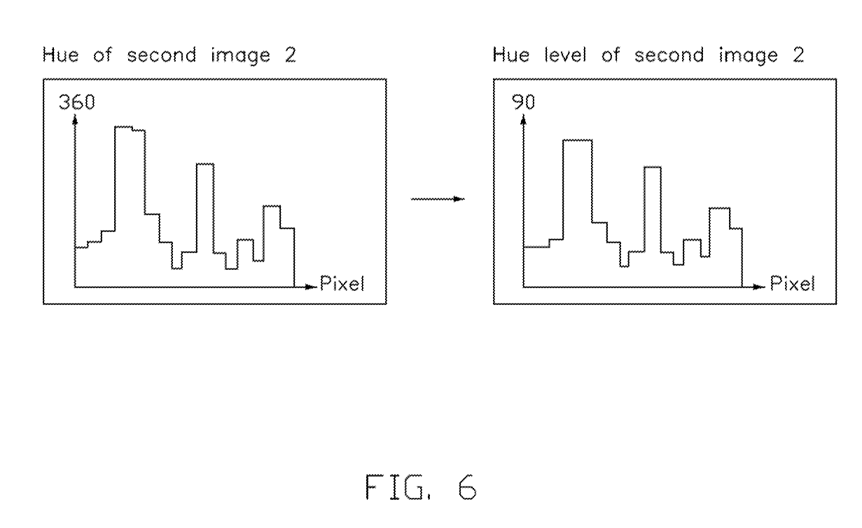

FIG. 6 illustrates a third process that the computing module 12 uses to process the second image 2 to get a value of Hue and a value of Hue level of the second image 2.

In a histogram of the value of hue of the second image 2 in FIG. 6, a small difference in the value of hue can be regarded as not affecting the value of hue level. Thus, errors caused by light or lighting angles can be reduced.

The histogram of the value of hue of the second image 2 is similar to a histogram of the value of hue level of the first image 1. Thus, the hue level of the second image 2 can be configured to distinguish between persons.

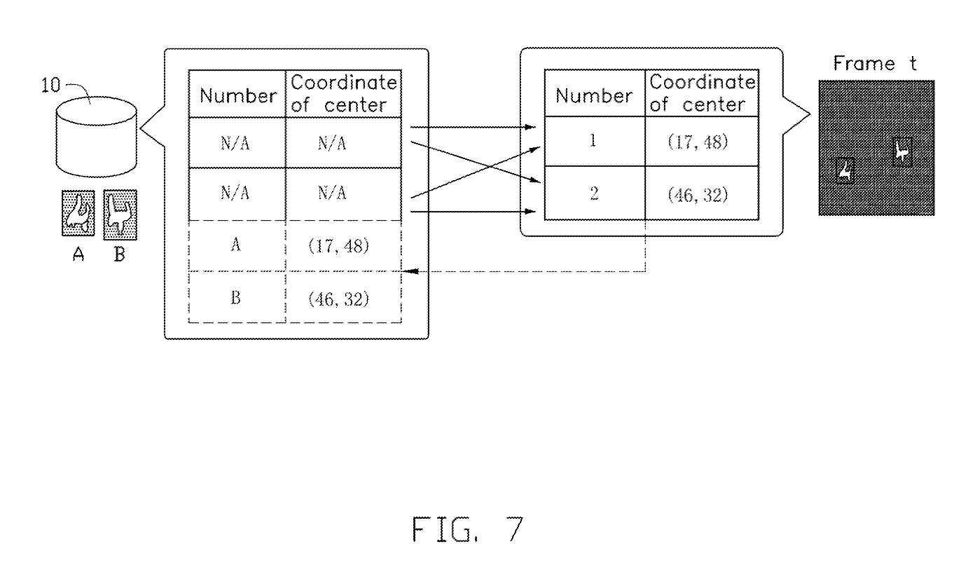

FIG. 7 illustrates a process employed by the computing module 12 to compare the images.

The extracting module 11 extracts a plurality of frames of images from the first signal. The extracting module 11 provides the plurality of frames of images to the computing module 12.

When the storing module 10 does not store information of persons to be monitored, the computing module 12 determines that the first image 1 and the second image 2 are introducing new persons to be monitored.

The computing module 12 defines the coordinates (a1, b1) of the center of the first image 1 to be a center of the coordinates of a first person A to be monitored.

The computing module 12 defines the coordinates (a2, b2) of the center of the second image 2 to be a center of the coordinates of the second person B to be monitored.

The coordinates of persons to be monitored may be changed in other frames of images. The computing module 12 monitors the coordinates of persons as indications of their presence.

In one embodiment, the extracting module 11 extracts a plurality of images from a second frame. The computing module 12 compare coordinates of images in a second frame to the coordinates (a1, b1) of the first person A in the first frame. The computing module 12 calculates a distance between the coordinates (a1, b1) of the first person A to coordinates of images from the extracting module 11. The computing module 12 compares and finds an image which has a smallest distance to the first person A first because a person's movement between two frames must be small.

In at least one embodiment, the computing module 12 selects three images which are closest to the person to be monitored between two frames.

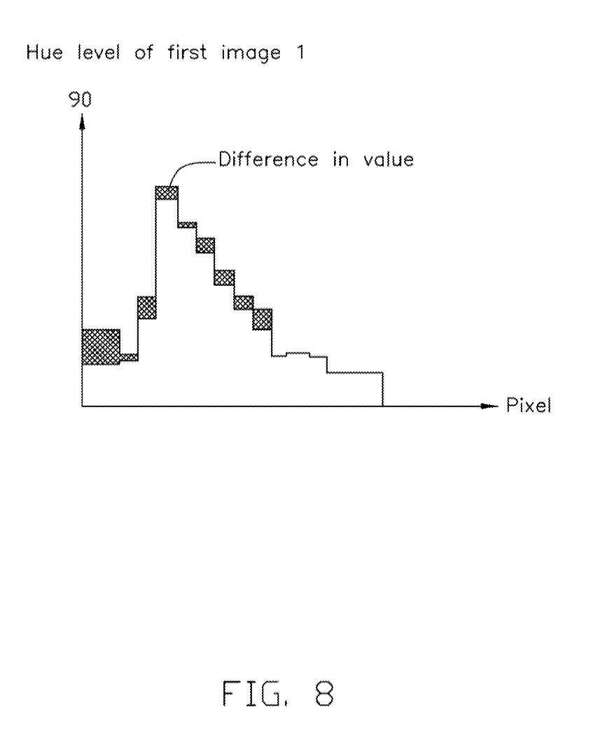

FIG. 8 illustrates a comparison of values of hue level of images between two frames based on the first person A. Parts which are not overlap are a different value.

The computing module 12 defines an image of a value of hue level which has a smallest difference in value to be an image of the first person A in a next frame.

In one embodiment, the computing module can get an image of the first person A in the next frame through the comparison of values of hue level only.

In one embodiment, when an image in a frame is established to be an image of a person x, the image in the frame and the image of the person x are deleted from all queues awaiting comparison.

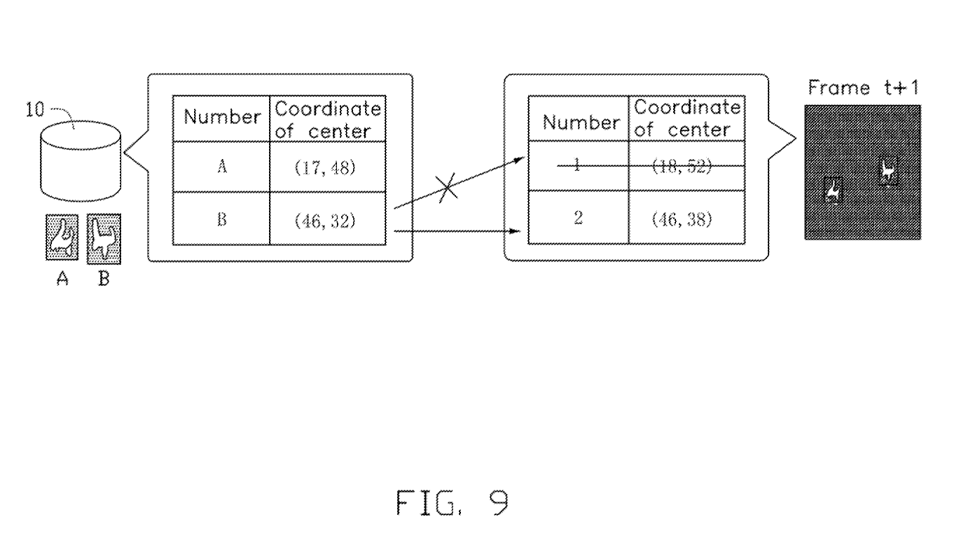

FIG. 9 illustrates that when the computing module 12 determines that a second image 2 of a t+1 frame is the second person B, the computing module 12 deletes all comparisons about the second person B of the t+1 frame in the waiting queue.

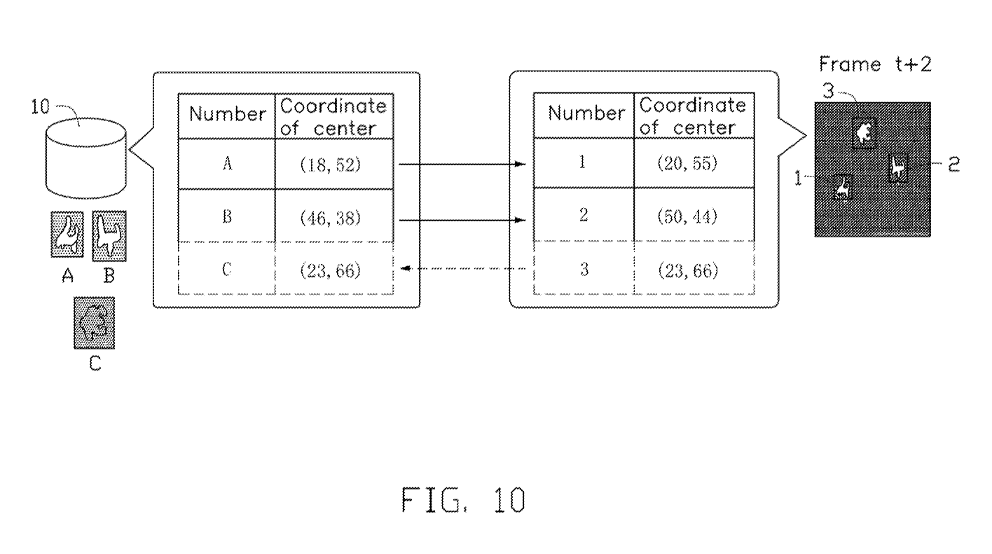

FIG. 10 illustrates that when all persons to be monitored are established in one frame and there are still images of persons in respect of whom a mapping has not yet been established, the computing module 12 defines the images as images of new persons and stores information of them as new persons to be monitored. The computing module 12 also numbers the new persons to be monitored.

In one embodiment, when the computing module 12 adds a new person L to be monitored and the person L undergoing monitoring cannot be mapped in next or future frames, the computing module 12 deletes information of the person L.

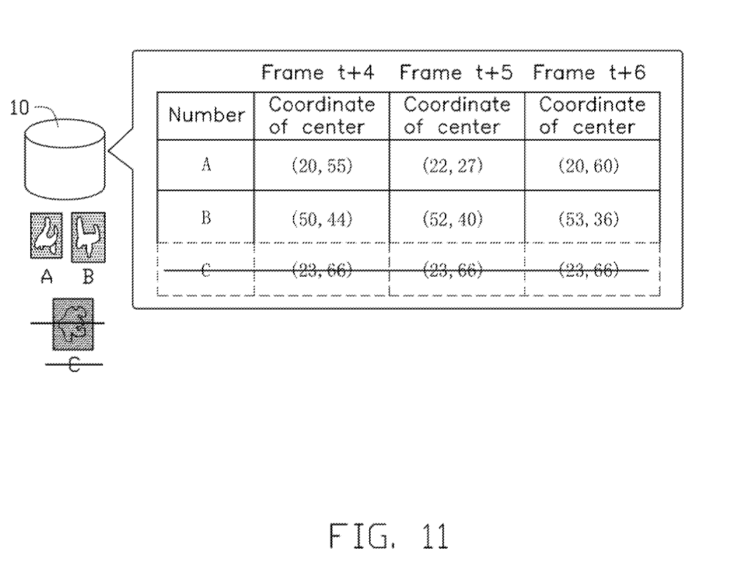

FIG. 11 illustrates that when coordinates of a person C to be monitored is unchanging in next or future frames, the computing module 12 deletes information of the person C.

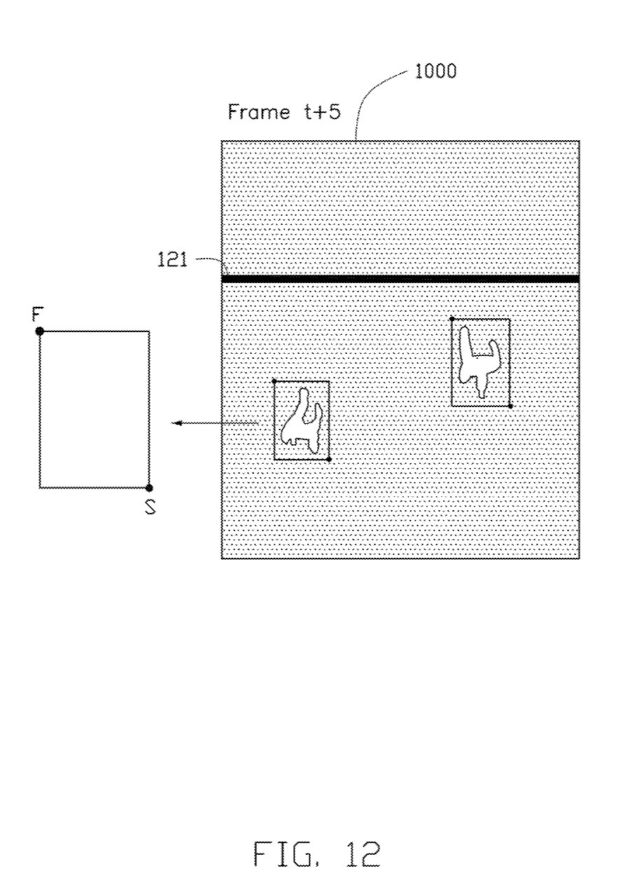

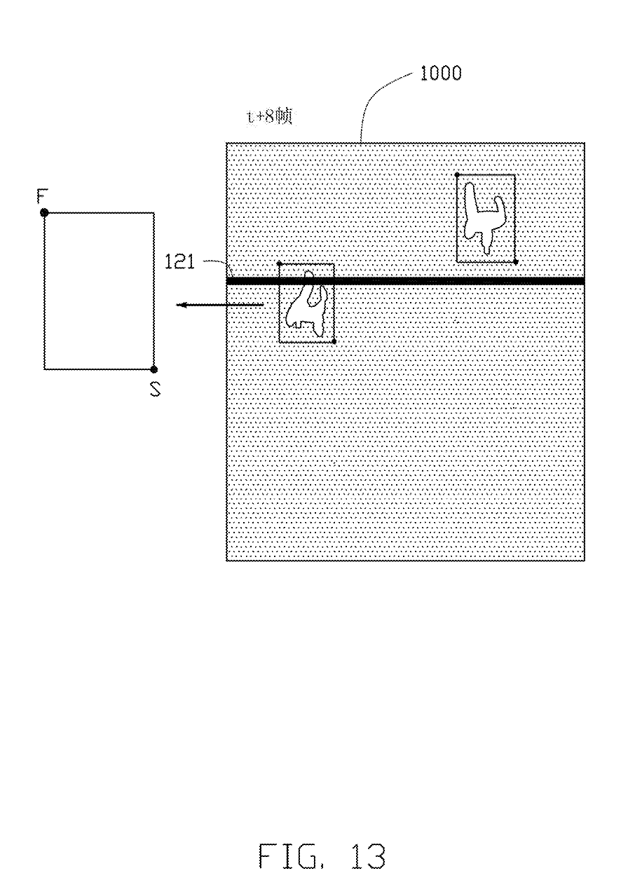

FIGS. 12-13 show an embodiment that the monitoring device 100 for counting people.

The computing module 12 set a counting line 121 in a monitoring area 1000.

In one frame, the first image 1 and the second image 2 are in the monitoring area 1000. Each of the first image 1 and the second image 2 has a first endpoint F and a second endpoint S. The first endpoint F is closer to the counting line 121 than to the second endpoint S. When the first endpoint F and the second endpoint S pass the counting line 121, in that order, in future frames, the computing module 12 determines that the person has passed the counting line 121 and thus increases the count by 1.

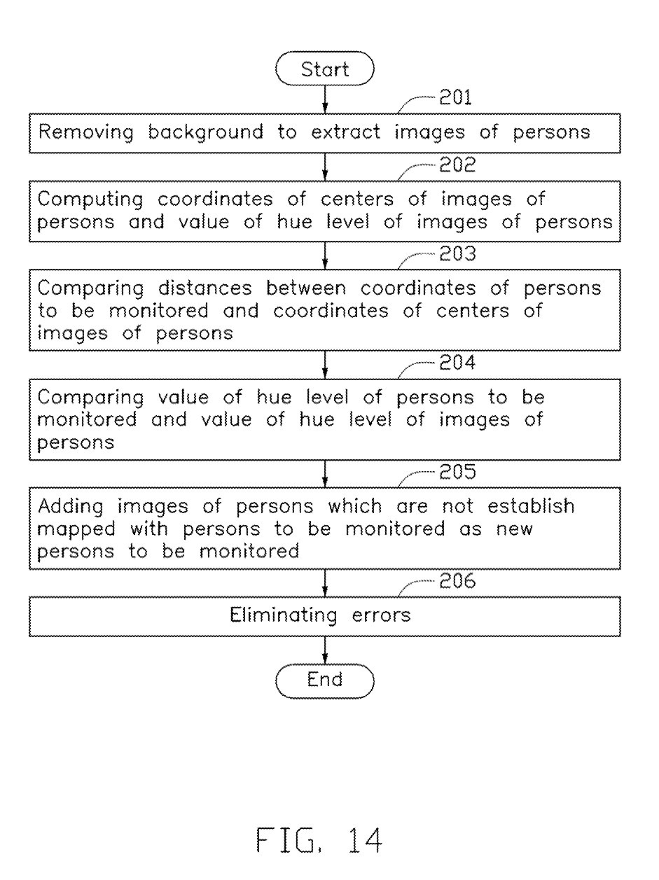

FIG. 14 illustrates a flowchart of a monitoring method 200. The example method is provided by way of example, as there are a variety of ways to carry out the method. The method described below can be carried out using the configurations illustrated in FIG. 1, for example, and various elements of these figures are referenced in explaining the example method. Each block shown in FIG. 14 represents one or more processes, methods, or subroutines carried out in the example method. Furthermore, the illustrated order of blocks is by example only, and the order of the blocks can be changed. Additional blocks can be added or fewer blocks can be utilized without departing from this disclosure. The example method can begin at block 201.

Block 201, removing background to extract images of persons.

Block 202, computing coordinates of centers of images of persons and value of hue level of images of persons.

Block 203, comparing distances between coordinates of persons to be monitored and coordinates of centers of images of persons.

Block 204, comparing value of hue level of persons to be monitored and value of hue level of images of persons.

Block 205, adding images of persons which are not establish mapped with persons to be monitored as new persons to be monitored.

Block 206, eliminating errors.

The monitoring method 200 can comprise: deleting an image in a frame and an image of a person from all queues of comparison when the image in the frame is established to be the image of the person.

The monitoring method 200 can comprise: deleting information of a person when the person monitor cannot be mapped with images of persons in next frames.

The monitoring method 200 can comprise: deleting information of a person when a coordinate of the person is not changed in next frames.

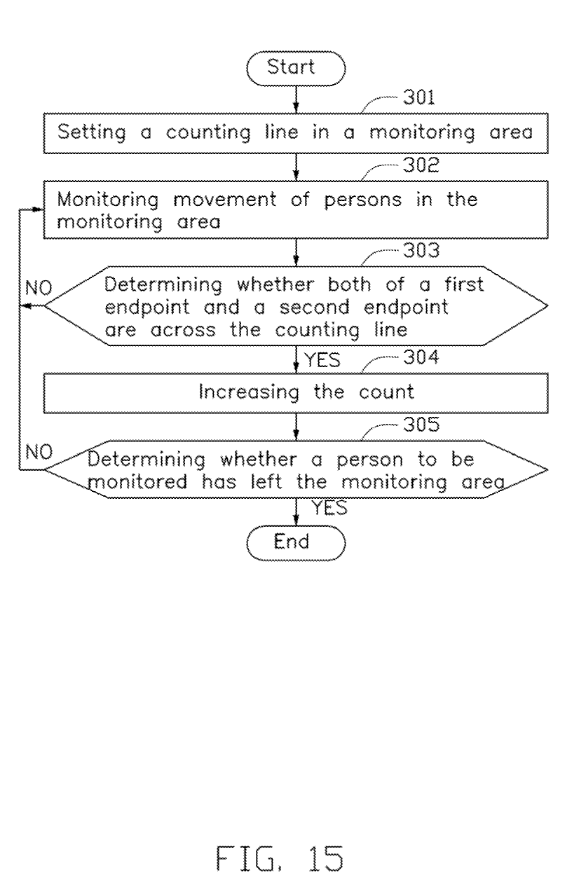

FIG. 15 illustrates a flowchart of a counting method 300. The example method is provided by way of example, as there are a variety of ways to carry out the method. The method described below can be carried out using the configurations illustrated in FIG. 1, for example, and various elements of these figures are referenced in explaining the example method. Each block shown in FIG. 15 represents one or more processes, methods, or subroutines carried out in the example method. Furthermore, the illustrated order of blocks is by example only, and the order of the blocks can be changed. Additional blocks can be added or fewer blocks can be utilized, without departing from this disclosure. The example method can begin at block 301.

Block 301, setting a counting line in a monitoring area.

Block 302, monitoring movement of persons in the monitoring area.

Block 303, determining whether both of a first endpoint and a second endpoint are across the counting line. When both of a first endpoint and a second endpoint are across the counting line, the method proceeds to block 304. When not both of a first endpoint and a second endpoint are across the counting line, the method proceeds to block 302.

Block 304, increasing the count.

Block 305, determining whether a person to be monitored has left the monitoring area. When the person has left the monitoring area, the method ends. When the person has not left the monitoring area, the method proceeds to block 302.

While the disclosure has been described by way of example and in terms of the embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A monitoring device, comprising:
a signal acquisition module comprising a camera to provide a first signal;
an extracting module to extract images of persons from the first signal; and
a computing module comprising at least one processor to process the images of persons from the extracting module;
wherein the extracting module is configured to remove background of the first signal and extract images of persons for the computing module, the computing module is configured to get a coordinate of a center of each of images of persons and a value of hue of each of images of persons, the computing module is configured to match images of persons to persons to be monitored.

2. The monitoring device as claim 1, wherein the computing module stores images of persons in a first frame of the first signal as new persons to be monitored.

3. The monitoring device as claim 2, wherein the computing module numbers the new persons to be monitored.

4. The monitoring device as claim 1, wherein the extracting module check pixels comprised in images of persons through connected component analysis-labeling.

5. The monitoring device as claim 4, wherein the extracting module cut the images of persons off from the image of the first signal.

6. The monitoring device as claim 1, further comprising a storing module to store information of persons to be monitored.

7. The monitoring device as claim 1, wherein the computing module set a counting line in a monitoring area, each image of persons in the monitoring area has a first endpoint and a second endpoint, when both of the first endpoint and the second endpoint are across the counting line, the computing module increase the count.

8. A monitoring method, comprising:
removing background to extract images of persons;
computing coordinates of centers of images of persons and value of hue level of images of persons;
comparing distances between coordinates of persons to be monitored and coordinates of centers of images of persons;
comparing value of hue level of persons to be monitored and value of hue level of images of persons;
adding images of persons which are not establish mapped with persons to be monitored as new persons to be monitored.

9. The monitoring method as claim 8, further comprising: eliminating errors.

10. A counting method, comprising:
setting a counting line in a monitoring area;
monitoring movement of persons in the monitoring area;
determining whether both of a first endpoint and a second endpoint are across the counting line;
increasing the count;
determining whether a person to be monitored has left the monitoring area.
